(19) United States
(12) Patent Application Publication
(10) Pub. No.: US 2026/0238310 A1
(43) Pub. Date: Aug. 13, 2026

(54) Layer-1 Measurements for Multi-Panel Receiving User Equipment

(71) Applicant: Apple Inc., Cupertino, CA (US)

(72) Inventors: Xiang CHEN, Palo Alto, CA (US); Jie CUI, San Jose, CA (US); Manasa RAGHAVAN, Sunnyvale, CA (US); Qiming LI, Beijing (CN); Yang TANG, San Jose, CA (US); Yuexia SONG, Beijing (CN)

(21) Appl. No.: 19/155,670

(22) PCT Filed: Feb. 14, 2023
(86) PCT No.: PCT/CN2023/075905

§ 371 Date: Aug. 12, 2025

(51) Int. Cl. H04B 7/06; H04W 8/22; H04W 72/21; H04W 76/20; H04W 80/02

(52) U.S. Cl. CPC H04B 7/06956; H04B 7/06968; H04W 8/22; H04W 72/21; H04W 76/20; H04W 80/02

(57) ABSTRACT

A user equipment (UE) includes a first and second receiving (RX) panel and is configured to determine the UE is to perform Layer-1 (L1) measurements on beams transmitted by a first and second transmission and reception point (TRP), wherein the UE tests a minimum number of beams using beam sweeping operations prior to selecting the beams for L1 measurements, wherein the minimum number corresponds to a number of beam sweeping rounds. In a first beam sweeping round, the UE simultaneously activates the first and second RX panels to generate one RX beam for a beam sweeping operation. In subsequent beam sweeping rounds, the UE performs beam sweeping operations until the minimum number of beams are tested, selects a first beam of the first TRP and a second beam of the second TRP for the L1 measurements and performs the L1 measurements.

### TECHNICAL FIELD

The present disclosure generally relates to wireless communication, and in particular, to layer-1 measurements for multi-panel receiving user equipment.

### BACKGROUND

A user equipment (UE) may connect to a network via a base station. The base station may control multiple transmission and reception points (TRPs). The UE may include multiple reception (RX) panels for receiving signals from more than one TRP. This may be described as multi-TRP (mTRP) RX.

Typically, a UE will perform Layer-1 (L1) measurements on signals received from the base station. These L1 measurements may include, for example, Reference Signal Received Power (RSRP), Signal Interference+Noise Ratio (SINR), Radio Link Monitoring (RLM), Beam Failure Detection (BFD), Candidate Beam Detection (CBD), etc. However, when operating in mTRP RX mode, the UE may be able to make L1 measurements on the signals received from more than one TRP. The behavior of the UE needs to be defined when the UE is capable of making L1 measurements from more than one TRP.

### SUMMARY

Some exemplary embodiments are related to a method performed by a user equipment (UE) comprising a first receiving (RX) panel and a second RX panel. The method includes determining the UE is to perform Layer-1 (L1) measurements on beams transmitted by a first transmission and reception point (TRP) of a base station and a second TRP of the base station, wherein the UE tests a minimum number of beams of the first and second TRP using beam sweeping operations prior to selecting the beams for L1 measurements, wherein the minimum number of beams corresponds to a number of beam sweeping rounds, in a first beam sweeping round, simultaneously activating the first and second RX panels, wherein each RX panel generates one RX beam for a beam sweeping operation, in subsequent beam sweeping rounds, performing beam sweeping operations until the minimum number of beams of the first and second TRP are tested, selecting a first beam transmitted by the first TRP and a second beam transmitted by the second TRP for the L1 measurements based on at least the beam sweeping operations and performing the L1 measurements on signals received in the first beam and the second beam.

Other exemplary embodiments are related to a user equipment (UE) having a first receiving (RX) panel, a second RX panel and a processor communicatively coupled to the first and second Rx panels. The processor is configured to determine the UE is to perform Layer-1 (L1) measurements on beams transmitted by a first transmission and reception point (TRP) of a base station and a second TRP of the base station, wherein the UE tests a minimum number of beams of the first and second TRP using beam sweeping operations prior to selecting the beams for L1 measurements, wherein the minimum number of beams corresponds to a number of beam sweeping rounds, in a first beam sweeping round, simultaneously activate the first and second RX panels, wherein each RX panel generates one RX beam for a beam sweeping operation, in subsequent beam sweeping rounds, perform beam sweeping operations until the minimum number of beams of the first and second TRP are tested, select a first beam transmitted by the first TRP and a second beam transmitted by the second TRP for the L1 measurements based on at least the beam sweeping operations and perform the L1 measurements on signals received in the first beam and the second beam.

Still further exemplary embodiments are related to a method performed by a base station having a first transmission and reception point (TRP) and a second TRP. The method includes receiving UE capability information indicating whether a user equipment (UE) is capable of (i) activating only a single receiving (RX) panel at a time or (ii) simultaneously activating a first RX panel and a second RX panel for performing L1 measurements on separate beams transmitted by the first TRP and second TRP and configuring reference signals (RSs) to be transmitted to the UE based on the capability information.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary arrangement comprising two TRPs transmitting to a UE according to various exemplary embodiments.

FIG. 5 shows examples of current measurement periods for L1 measurements when a UE uses one RX panel to measure a single beam from a single TRP.

FIG. 6 shows a first example of a UE performing a beam sweeping operation for purposes of L1 measurements according to various exemplary embodiments.

FIG. 7 shows a second example of a UE performing a beam sweeping operation for purposes of L1 measurements according to various exemplary embodiments.

FIG. 8 shows a signaling diagram for the UE to report a capability related to mTRP L1 measurements according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) comprising a multi-panel reception (RX) capability that is receiving signals from more than one transmission and reception point (TRP). Specifically, the exemplary embodiments are related to the UE performing Layer-1 (L1) measurements on the signals received from the multiple TRPs.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). The exemplary embodiments are also described with reference to the TRPs transmitting in NR frequency range 2 (FR2). However, reference to a 5G NR network, a gNB or a specific frequency range for the transmissions is merely provided for illustrative purposes. The exemplary embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

The network may support multi-TRP (mTRP) based transmission. From the perspective of the UE, mTRP operation may include establishing and maintaining a connection with multiple TRPs at the same time. To receive the mTRP transmissions, the UE may be equipped with multiple reception (RX) panels (e.g., antenna panels and receive chains), wherein each RX panel may receive a signal from an individual TRP. As those skilled in the art will understand, the signals transmitted by each TRP may include reference signals (RS) that may be used by the UE to perform certain measurements. These measurements may include L1 measurements such as RSRP, SINR, RLM, BFD, CBD, etc. However, it should be understood that the exemplary embodiments are not limited to these L1 measurements but may be applied to any type of L1 measurements.

According to the exemplary embodiments, techniques are introduced that enable enhanced FR2-1 UEs with simultaneous downlink (DL) reception from different directions with different Quasi Co-Location (QCL) TypeD RSs on a single component carrier. As will be described in greater detail below, these techniques may be used to reduce L1 measurement periods (or delay) and/or relax the measurement/scheduling restrictions.

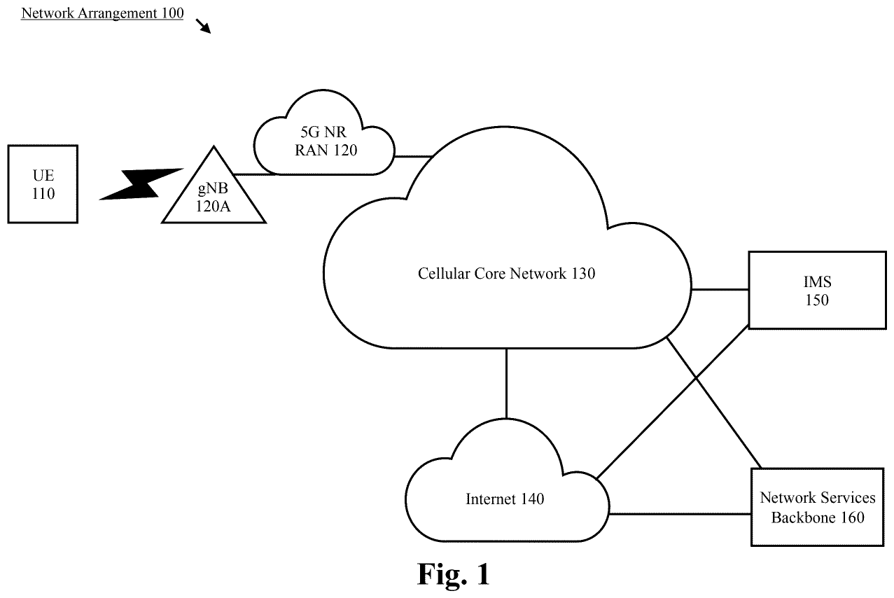

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e. g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes.

Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam. As indicated above, in some examples, the terms “TRP” and “cell” may be used interchangeably to generally refer to the same connection and/or node.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

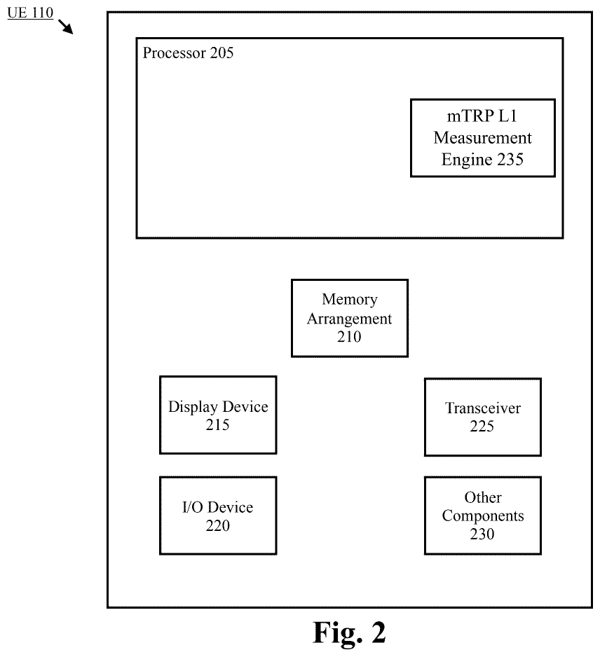

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a mTRP L1 measurement engine 235. The mTRP L1 measurement engine 235 may perform various operations related to simultaneous downlink (DL) reception of reference signals from multiple TRPs for L1 measurements. These operations include, but are not limited to, determining a number of beam sweeping operations to perform, determining a measurement period for the L1 measurements, reporting capability information to the network and determining whether to relax scheduling or measurement restrictions.

The above referenced engine 235 being applications (e. g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

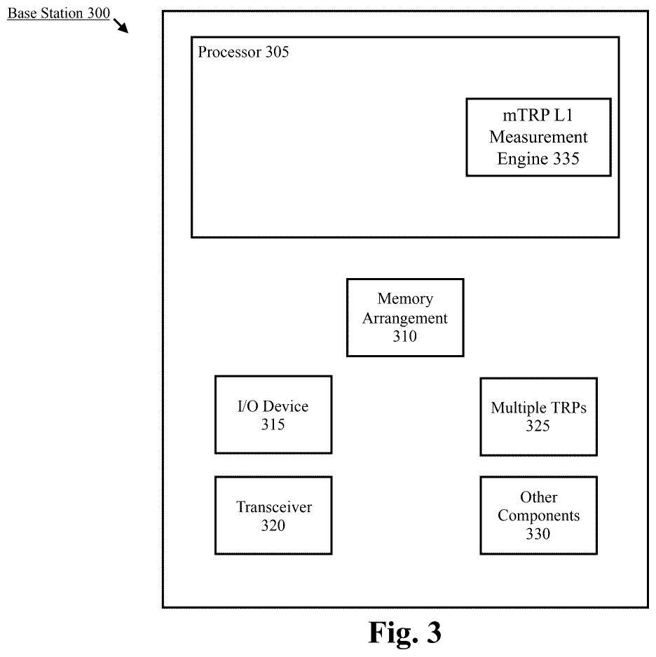

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 325 and other components 330. The other components 330 may include, for example, an audio input device, an audio output device, a battery, a data acquisition device, ports to electrically connect the base station 300 to other electronic devices and/or power sources, TxRUS, transceiver chains, antenna elements, antenna panels, etc.

As indicated above, in some scenarios, the multiple TRPs 330 may be deployed locally at the base station 300. In other scenarios, one or more of the multiple TRPs may be deployed at physical locations remote from the base station 300 and connected to the base station via a backhaul connection. The base station 300 may be configured to control the multiple TRPs 330 and perform operations such as, but not limited to, assigning resources, configuring reference signals, implementing beam management techniques, etc.

The processor 305 may be configured to execute a plurality of engines for the base station 300. For example, the engines may include a mTRP L1 measurement engine 335 that may perform various operations related to simultaneous downlink (DL) reception of reference signals by a UE from multiple TRPs for L1 measurements. These operations include, but are not limited to, configuring reference signals for the UE, determining a measurement period for the L1 measurements, receiving UE capability information and determining whether to relax scheduling or measurement restrictions.

The above noted engine 335 being an application (e.g., a program) executed by the processor 305 is only exemplary. The functionality associated with the engine 335 may also be represented as a separate incorporated component of the base station 300 or may be a modular component coupled to the base station 300, e. g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

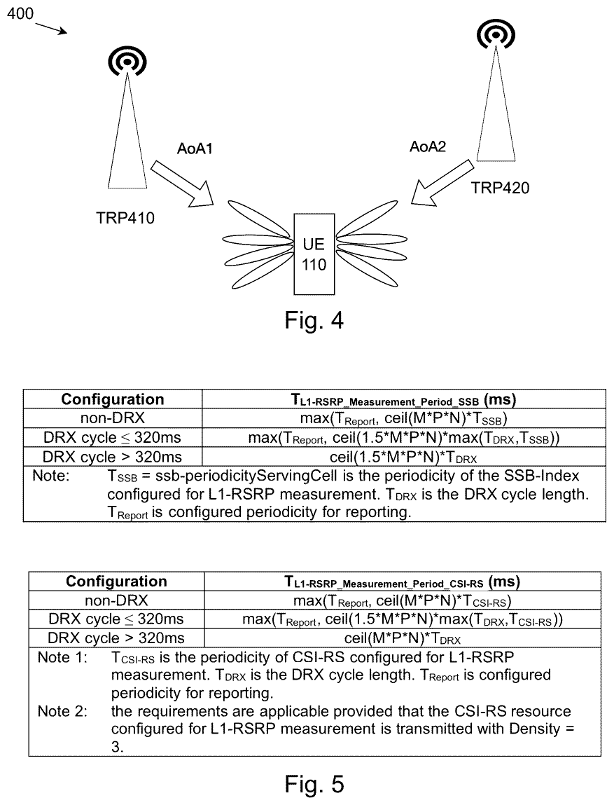

FIG. 4 shows an exemplary arrangement 400 comprising two TRPs 410 and 420 transmitting to a UE 110 according to various exemplary embodiments. FIG. 4 illustrates an example where the UE 110 has activated two RX panels and is receiving signals from a first TRP 410 via a first RX panel and is receiving signals from a second TRP 420 via a second RX panel.

As shown in FIG. 4, the UE 110 is receiving beams at an Angle of Arrival (AoA) specific to each TRP, e.g., AoA1 from TRP 410 and AoA2 from TRP 420. As described above, these beams may comprise signals in FR2-1 with different QCL TypeD RSs. The UE 110 may use each of the two beams for L1 measurements. A result of the UE 110 using both beams for L1 measurements may be that the measurement period can be reduced or the existing measurement period may be used and scheduling restrictions can be relaxed. Manners of implementing the exemplary embodiments to obtain these results will be described in greater detail below.

FIG. 5 shows examples of current measurement periods for L1 measurements when a UE uses one RX panel to measure a single beam from a single TRP. This means the UE is measuring a single RX beam at any time. Thus, the tables in FIG. 5 are based on the assumption that the UE is performing measurements on a signal received from a single TRP or gNB. The examples of FIG. 5 show the L1-RSRP measurement period (or delay) that is defined in 3GPP TS 38.133. Table 9.5.4.1-2 is for Synchronization Signal Block (SSB)-based L1-RSRP measurement and Table 9.5.4.2-2 is for Channel State Information (CSI) RS-based L1-RSRP measurement. It should be understood that these tables are only provided as examples and other L1 measurements may have different measurement periods.

However, for the examples provided above and for other L1 measurement periods, one of the parameters used to calculate the measurement period is a beam sweeping factor N. The current beam sweeping factor N for single panel RX has a value of 8 assuming a UE uses a single activated RX panel to perform beam sweeping. Since at any given time only one panel is activated, the UE can only generate one RX beam at a time. Thus, the beam sweeping factor of 8 means that UE needs N occasions to sweep N different RX beams in each round of beam sweeping for L1 measurements. The exemplary embodiments of multi-panel RX allows the beam sweeping value to be reduced to a number less than 8. In the exemplary embodiments, this new beam sweeping factor may be referred to as N′, where N′<8. Examples of values for N′ will be provided below. However, it should be apparent from the formulas in the tables of FIG. 5 that reducing the value of N will reduce the measurement period.

In some exemplary embodiments, previously determined Layer-3 (L3) measurements may be used to down select panels/beams, e.g., to reduce the beam sweeping factor N. Those skilled in the art will understand that while the exemplary embodiments are being described with reference to L1 measurements, the UE 110 may perform many other measurements on the signals received from the TRPs 410 and 420, including L3 measurements. L3 measurements are typically used for operations such as handover and may include the same general types of measurements performed for L1, e. g., RSRP. The L3 measurements may include beam level measurements, e.g., measurements related to individual beams or groups of beams that are being transmitted by a TRP.

In the exemplary embodiments, the UE 110 may use the beam level L3 measurements (or any other measurements) that have inherent information about the beams being transmitted by each of the TRPs 410 and 420 to reduce the number of sweeping fine beams for L1 measurement. This means the beam sweeping factor N can be reduced to N′ (e.g., where N′<8).

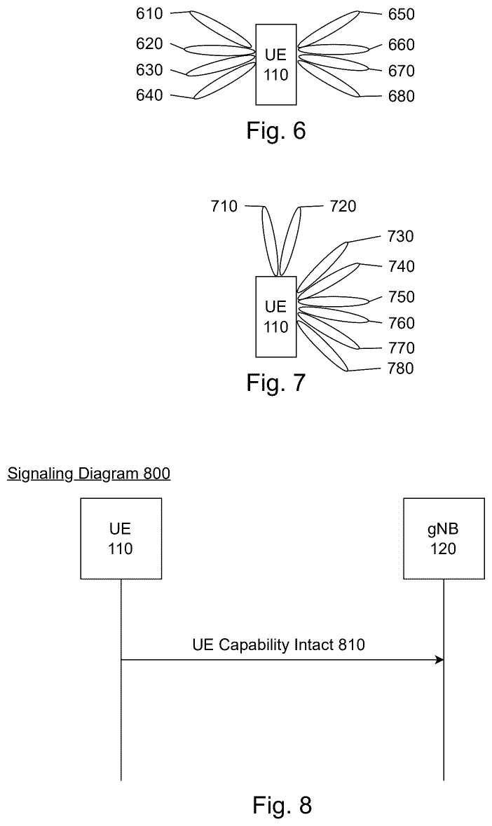

FIG. 6 shows a first example of a UE 110 performing a beam sweeping operation for purposes of L1 measurements according to various exemplary embodiments. In this example, it may be considered that the UE 110 has a first RX panel activated that is performing a beam sweeping operation for signals from the first TRP 410. These beams generated by the first RX panel are labeled 610-640. Similarly, it may be considered that the UE 110 has a second RX panel activated that is performing a beam sweeping operation for signals from the second TRP 420. These beams generated by the second RX panel are labeled 650-680.

If all the beams 610-680 were used in a beam sweeping round, the beam sweeping factor would be the standard N, e.g., 4 on the first RX panel and 4 on the second RX panel. However, in this exemplary embodiment, the UE 110 may reduce the number of beams used for a beam sweeping round based on previously determined Layer-3 (L3) measurements. For example, previous L3 measurements may indicate that the UE 110 is unlikely to find a valid beam for L1 measurements for TRP 410 using beams 650-680 and thus, the UE 110 may only activate the beams 610-640 for the first RX panel. Similarly, based on the previous L3 measurements, the UE 110 may determine it is unlikely to find a valid beam for L1 measurements for TRP 420 using beams 610-640 and thus, the UE 110 may only activate the beams 650-680 for the second RX panel. Thus, in this example, the beams used for each round of beam sweeping for each TRP would be reduced from N to N′=4.

It should be understood that the above was only exemplary and the use of the previous L3 measurements may result in a different number or different combination of beam sweeping patterns being active.

In other exemplary embodiments, the previous L3 measurements are not used to reduce the panels/beams. In these exemplary embodiments, the fine beam sweeping will need to cover a sphere projected out from the UE 110. Thus, how much N may be reduced depends on UE implementation. The following figures provide examples of a reduction. It should be understood that the reduction is based on the fact that the UE 110 is capable of generating two beams pointing in different directions with two activated RX panels on each beam sweeping occasion and reducing the beam sweeping factor should still result in the UE 110 detecting a valid beam for L1 measurement purposes.

FIG. 6 showing the first example of a UE 110 performing a beam sweeping operation for purposes of L1 measurements may also be used to illustrate an example of the currently described exemplary embodiments. In this example, each RX panel can generate four beams pointing in different directions (e. g., beams 610-640 from RX panel 1 and beams 650-680 from RX panel 2). Since the UE can sweep two beams, e. g., 610 and 650, on the first beam sweeping occasion, 620 and 660 on the second occasion, 630 and 670 on the third occasion, and 640 and 680 on the fourth occasion, the UE only needs 4 such beam sweeping occasions to complete sweeping of 8 beams. Thus, in this example, the beam sweeping factor would be reduced to N′=4, e.g., 2 on the first RX panel and 2 on the second RX panel.

It should be understood that the above was only exemplary and there may be other beam sweeping patterns used to reduce N to N′. For example, on the first occasion beams 610 and 670 are swept, on the second occasion beams 630 and 680 are swept, on the third occasion beams 620 and 660 are swept, and on the fourth occasion beams 640 and 650 are swept. Other combinations of beam sweeping patterns may be active at a given time.

The number of active beam sweeping patterns and the combination of the active beam sweeping patterns may be based on any factor or combination of factors. For example, factors may include a location/orientation of the UE 110, the cell on which the UE 110 is camped, and the relative position between the UE and the TRP.

FIG. 7 shows a first example of a UE 110 performing a beam sweeping operation for purposes of L1 measurements according to various exemplary embodiments. In this example, RX panel 1 can generate two beams, e.g., 710 and 720, and RX panel 2 can generate six beams, e.g., 730-780.

In this exemplary embodiment, the UE 110 may again reduce the beam sweeping factor (e.g., the number of occasions needed to sweep 8 beams). For example, on the first occasion beams 710 and 730 are swept, on the second occasion beams 720 and 740 are swept. However, on the third occasion, only beam 750 is swept, as there is no more beams from RX panel 1 to be swept. Subsequently, beams 760-780 are swept on the fourth, fifth and sixth occasion, respectively. Comparing FIG. 7 to FIG. 6, it can be seen that the number of beams each RX panel can generate may affect the beam sweeping operations. Thus, in this example, the beam sweeping factor would be reduced to N′=6, e.g., 2 on the first RX panel and 4 on the second RX panel.

Similar to the first example with respect to the currently described exemplary embodiments, it should be understood that the above was only exemplary and there may be other manners of reducing N to N′ and the combination of beam sweeping patterns that are activated for a particular RX panel may be determined based on any relevant factor.

In some exemplary embodiments the new beam sweeping factor, N′<8, may be a range of values that may be hard coded into the standards (e.g., 3GPP standards and UEs capable of activating two RX panels at a time need to meet the corresponding L1 measurement delay requirement for each N.

In other exemplary embodiments, the value of N′ may be a UE capability. In these exemplary embodiments, the UE may report various information to the network. For example, the UE may report the value of N′, whether the UE is operating with one or two active RX panels at a time for L1 measurement purposes, etc.

FIG. 8 shows a signaling diagram 800 for the UE 110 to report a capability related to mTRP L1 measurements according to various exemplary embodiments. The signaling diagram 800 is performed between the UE 110 and the gNB 120A. As described above, the UE 110 may perform an association procedure to communicate with the 5G NR RAN 120 via the gNB 120A. As part of this association procedure the UE 110 may send capability information to the gNB 120A. While the exemplary embodiments describe the UE capability information being provided during an association procedure it should be understood that the UE capability information may be provided to the gNB 120A at any time when the UE 110 is camped on the gNB 120A and may also be updated periodically while the UE 110 is camped on the gNB 120A.

Thus, in 810, the UE 110 will send UE capability information to the gNB 120A. The UE capability information may include the value of N′, e.g., N′<8. In the same UE capability message (or in a different UE capability message), the UE 110 may also report whether the UE 110 operates with one or two active RX panels at a time for L1 measurement purposes.

In some exemplary embodiments, the UE 110 may only report the value of N′ and the gNB 120A may then infer that since the UE 110 supports a lower beam sweeping factor, the UE 110 will have two active RX panels at a time for L1 measurement purposes.

In other exemplary embodiments, the UE 110 may report both the N′ and whether the UE 110 is operating with one or two active RX panels at a time for L1 measurement purposes. In this case, the UE 110 may have the ability to use one or two RX panels and switch between one or two RX panels based on any individual factor. If the UE 110 reports N′ but that it is currently only supporting one RX panel, the gNB 120A will understand that the N′ value is not valid and the original value of N is applicable.

The UE capability information may be reported via any signaling mechanism, e.g., Uplink Control Information (UCI), Medium Access Control Control Element (MAC CE), Radio Resource Control (RRC) signaling, etc.

In each of the above described exemplary embodiments it was described that in the mTRP L1 measurement scenario, it is possible to reduce N to N′. In some exemplary embodiments, this reduction of N to N′ may be used to reduce the L1 measurement delay, e.g., based on the formulas described above with reference to FIG. 5. In these exemplary embodiments, the L1 measurement delay is reduced but the measurement and/or scheduling restrictions that apply to the current single TRP L1 measurements remain unchanged.

In other exemplary embodiments, this reduction of N to N′ may be used to change the measurement and/or scheduling restrictions. In these exemplary embodiments, even though the beam sweeping factor N is reduced to N′ as described above by way of example, the determination of the L1 measurement delay is still based on the value of N being assumed to be 8, e.g., the calculated L1 measurement delay is the same for the single TRP and mTRP scenario. However, by leaving the L1 measurement delay the same, this allows the measurement and/or scheduling restrictions to be relaxed.

The following provides examples of exemplary manners of relaxing the scheduling restrictions. However, those skilled in the art will understand that these exemplary manners of relaxing the scheduling restrictions may be applied equally to the measurement restrictions.

In some exemplary embodiments, during the L1 measurement period, e. g., max (T_{Report}, ceil (M*P*N)*T_{SSB}) for non-DRX SSB based L1 measurement as shown in FIG. 5. The network may assume the UE will use the first ceil (M*P*N′)*T_{SSB} for measurement, and thus, the scheduling restriction for the remaining time can be lifted, e.g., max (T_{Report}, ceil (M*P*N) *T_{SSB})−ceil (M*P*N′)*T_{SSB}.

In other exemplary embodiments, the UE may take one T_{SSB} for measurement and the next (N-N′)/N′ T_{SSB} for data reception, e.g., alternating between the two modes. These exemplary embodiments may be more generally described as including a pre-defined pattern that may be specified, e.g., 1110, meaning the first three T_{SSB} are used for measurement, and the last T_{SSB} is used for data reception. This pattern can either be hard coded in the standards (e.g., 3GPP standards) or dynamically signaled by the UE or network via UCI/DCI, MAC CE or RRC.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE) comprising a first receiving (RX) panel and a second RX panel, the method comprising:
determining the UE is to perform Layer-1 (L1) measurements on beams transmitted by a first transmission and reception point (TRP) of a base station and a second TRP of the base station, wherein the UE tests a minimum number of beams of the first and second TRP using beam sweeping operations prior to selecting the beams for L1 measurements, wherein the minimum number of beams corresponds to a number of beam sweeping rounds;
in a first beam sweeping round, simultaneously activating the first and second RX panels, wherein each RX panel generates one RX beam for a beam sweeping operation;
in subsequent beam sweeping rounds, performing beam sweeping operations until the minimum number of beams of the first and second TRP are tested;
selecting a first beam transmitted by the first TRP and a second beam transmitted by the second TRP for the L1 measurements based on at least the beam sweeping operations; and
performing the L1 measurements on signals received in the first beam and the second beam.

2. The method of claim 1, wherein the minimum number is based on previous Layer-3 (L3) measurements performed by the UE on signals received from the first TRP and second TRP.

3. The method of claim 1, wherein the number of beam sweeping rounds is a preconfigured number.

4. The method of claim 1, wherein the number of beam sweeping rounds is based on a capability of the UE.

5. The method of claim 4, further comprising:
reporting the number of beam sweeping rounds to the base station using one of Uplink Control Information (UCI), a Medium Access Control Control Element (MAC CE) or Radio Resource Control (RRC) signaling.

6. The method of claim 1, further comprising:
reporting the UE supports two active RX panels to the base station using one of Uplink Control Information (UCI), a Medium Access Control Control Element (MAC CE) or Radio Resource Control (RRC) signaling.

7. The method of claim 1, wherein, in each subsequent beam sweeping round, the first and second RX panels are simultaneously activated and each RX panel generates one RX beam for a beam sweeping operation.

8. The method of claim 1, wherein, in at least one of the subsequent beam sweeping rounds, the first RX panel is not activated and the second RX panel is activated, wherein the second RX panel generates one RX beam for a beam sweeping operation.

9. The method of claim 1, wherein the signals received in the first beam and the second beam are in a frequency range 2 (FR2) of the New Radio (NR) spectrum and a first signal of the first beam has different Quasi Co-Located TypeD reference signals (QCL TypeD RSs) than a second signal of the second beam.

10. The method of claim 1, further comprising:
determining a first L1 measurement period based on at least the number of beam sweeping rounds.

11. The method of claim 10, wherein measurement and scheduling restrictions during the first L1 measurement period are the same as when the UE supports only one active Rx panel for beam sweeping operations.

12. The method of claim 10, wherein a second L1 measurement period is determined based on the UE supporting only one active Rx panel for beam sweeping operations, the method further comprising:
relaxing one of a measurement restriction or a scheduling restriction based on a time difference between the first L1 measurement period and the second L1 measurement period.

13. The method of claim 11, wherein the relaxing comprises allowing the UE to perform data receptions in the time difference.

14. The method of claim 12, wherein performing data receptions is based on a pattern alternating between data receptions in the time difference and L1 measurements.

15. A method performed by a base station comprising a first transmission and reception point (TRP) and a second TRP, the method comprising:
receiving UE capability information indicating whether a user equipment (UE) is capable of (i) activating only a single receiving (RX) panel at a time or (ii) simultaneously activating a first RX panel and a second RX panel for performing L1 measurements on separate beams transmitted by the first TRP and second TRP; and
configuring reference signals (RSS) to be transmitted to the UE based on the capability information.

16. The method of claim 15, wherein the UE capability information comprises a number of beam sweeping rounds used by the UE to test a minimum number of beams of the first and second TRP using beam sweeping operations prior to selecting the beams for L1 measurements, wherein the number of beam sweeping rounds being less than a predetermined number indicates the UE is capable simultaneously activating the first and second RX panels for performing L1 measurements.

17. The method of claim 15, further comprising:
determining a first L1 measurement period based on at least the number of beam sweeping rounds.

18. The method of claim 17, further comprising:
determining a second L1 measurement period based on at least the predetermined number;
determining a relaxing of one of a measurement restriction or a scheduling restriction based on a time difference between the first L1 measurement period and the second L1 measurement period; and
signaling the relaxing of the measurement restriction or scheduling restriction to the UE.

19. The method of claim 18, wherein the relaxing comprises allowing the UE to perform data receptions in the time difference.

20. The method of claim 19, wherein performing data receptions is based on a pattern alternating between data receptions in the time difference and L1 measurements.
